(19) United States
(12) Patent Application Publication
(10) Pub. No.: US 2004/0024632 A1
(43) Pub. Date: Feb. 5, 2004

(54) Method of determining the effect of internet advertisement on offline commercial activity

(75) Inventor: Morgan Perry, Brier, WA (US)

Correspondence Address: Bennet K. Langlotz PC, Box 759, Genoa, NV, 89411, US

(73) Assignee: Avenue A, Inc.

(21) Appl. No.: 10/213,151

(22) Filed: Aug. 5, 2002

(51) Int. Cl. G06F 17/60

(52) U.S. Cl. 705/10

(57) ABSTRACT

A method of evaluating the commercial effects of Internet-based communication. The method begins with generating a sample of offline customers and attempting to determine an email address for each customer in the sample to generate an email list. A unique offline identifier is assigned to each customer on the email list, and a promotional email including the unique offline identifier is transmitted to the determined email addresses. User online activity in response to the promotional email is recorded, and the recorded activity is associated with the unique offline identifier and a unique online identifier. Offline purchasing activity is recorded for each customer after recording web browsing activity. The unique offline identifier is associated with the offline purchasing activity, the unique online identifier is associated with the web browsing activity, and the unique link between each customer's offline activity and that customer's online activity is established for those responding to the promotional email. The association of the online identifier and the off line identifier allows evaluation of the multi-channel commercial effect of the online marketing communication.

### FIELD OF THE INVENTION

This invention relates to internet communication, and more particularly to commercial and advertising communication methods that employ detailed user activity information while preserving user privacy.

### BACKGROUND AND SUMMARY OF THE INVENTION

The Internet is an effective tool for commercial communication. Companies use electronic communications to consumers to cost effectively promote their goods or services. The ability of advertising service companies to gather web browsing data has proven to be a useful tool for marketers, because unique device identifiers known as cookies are associated with the web browsing, as well as on-line purchasing activity by customers. An advertising service provider may generate a detailed but anonymous profile of a user, whose identity is unknown except for the unique anonymous identifier assigned to the user's computer or other browsing device, such as a mobile telephone or personal digital assistant. The activity and inactivity of each user may be associated with each users' prior activity or exposure to advertising or messaging treatments for analysis of marketing efforts. In particular, online advertising campaigns (which may include banner ads on websites, and direct email messages) may be analyzed effectively because the identifier collected for advertisement-serving can be the same as, or can be uniquely associated with, identifiers assigned or recorded at the time of purchase; the purchasing rates of those who were served an advertisement may be compared with those who did not see the advertisement or who saw modified advertisements to determine the degree of effect the advertisement had on purchasing.

While effective for determining the effect of advertisements on online purchasing, there has been no effective way to measure the effect of online advertising on offline purchasing, such as at retail stores or by telephone or mail. Offline purchasing includes any purchasing not conducted with the device on which the advertisements are viewed. Is it believed that many customers may conduct product research online, or may be influenced by online advertisements or emails, but make purchases offline in response to these online activities. Consequently, those offering online advertising have had difficulty fully quantifying the beneficial effects of their advertising.

Moreover, it has proven difficult to determine which online efforts have a greater beneficial effect than others, so that efforts cannot readily be improved or tailored to particular advertisers. This is a particular concern for the many advertisers whose offline sales volume is far greater than their online volume. If the readily-measurable online effects were representative of offline effects, then they would serve as a suitable proxy. However, in many or most cases, there are important differences in the demographics and other relevant purchasing characteristics of these two types of purchasers. Even limiting the analysis only to those who are active Internet users, there are believed to be unpredictable, variable, and significant differences between those who purchase online, and those who purchase offline.

In addition, there may be privacy concerns for some potential customers. Internet companies can readily gather limited anonymous information from visitors to digital properties (such as web sites), including recording the pages and advertisements viewed by the user, along with any other IP based activity (this covers HTTP (internet), smtp, and other IP based protocol). This information may be collected over time, from visits to many different digital properties, and may paint a detailed anonymous portrait that is useful in determining whether and with what promotional content to communicate. Such browsing information gathered about the user's browsing and other Internet activity lacks the means to contact the user. The gathered information is identified by a unique device identifier such as a “cookie” associated with either the device (if there are no profiles on the device) or the user's profile on the device used by the user for browsing, but this cookie does not identify the user, his email address, or any other personally identifiable information. Normally, this is merely a numeric identifier that is useful for identifying all the different browsing sessions conducted by the same user in domains where the communication service company is serving content into, and it is impossible to determine from the identifier the identity or location of the person using the device. Once assigned the identifier may also be used so that subsequent visits may be correlated with earlier visits to identify patterns, or to select which advertisements are served to the still-anonymous visitor.

The privacy concerns arise when companies seek to associate the detailed browsing history records with the actual personally identifiable information, such as might be learned in a sales transaction. Accordingly, many offline customers may be reluctant to enable an advertiser to associate their personal information with their browsing information, or may be reluctant to patronize an advertiser that has means to do so without the customer's knowledge or consent.

The present invention overcomes the limitations of the prior art by providing a method of evaluating the commercial effects of Internet-based communication. The method relies on creating or using a digital “space,” such as a web page, email, or wireless site (e.g., WAP), in which the customer/user can be identified with both the offline and the online identifiers at the same time, thus allowing for a unique link to be created between each of the two identifiers for each customer/user. The method includes generating a complete list or representative sample of offline customers, and determining unique digital addresses (e.g., email addresses, mobile phone numbers, etc.) for customers in the list or sample to generate a digital contact list. A unique and anonymous offline identifier, such as a customer ID, is assigned to each customer on the digital contact list. This unique and anonymous offline identifier is included in a digital communication to that list, such as a promotional email or mobile telephone message, such that the identifier is logged in a database record along with the online identifier, such as a cookie, recording user online activity, such as viewing of or clicking on the digital message. Once this unique association has been made between the unique and anonymous offline identifiers and the unique and anonymous online identifiers, offline activity (such as store or catalog purchases) for each customer can be associated with previous web browsing activity, such as viewing internet advertising messaging. Using test-and-control methods of serving advertising messages, this association can be improved to measuring response lift from no messaging or messaging unrelated to the advertiser (control) to the advertiser's messaging and also lift among advertiser messages.

### BRIEF DESCRIPTION OF THE DRAWINGS

FIG. 1 is a schematic block diagram showing the system and environment in which a preferred embodiment of the invention operates.

FIG. 2 is a schematic flow diagram showing a method of operation according to the preferred embodiment of the invention.

### DETAILED DESCRIPTION OF A PREFERRED EMBODIMENT

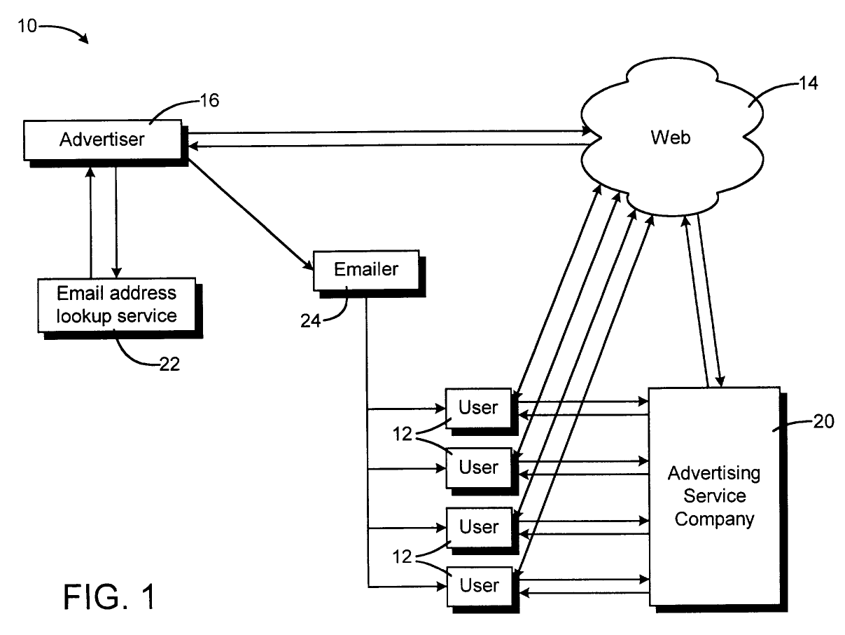

FIG. 1 shows an electronic communication system 10, operating in the environment of the Internet or other communication network. The diagram shows a set of Internet customer or user computer systems 12. Each Internet customer preferably uses one such Internet customer computer system to connect, via the Internet or web 14, to an Internet advertiser or advertiser computer system 16, to retrieve and display a Web page. An advertising service company 20 is also connected to the Internet, and thereby to the users and the other entities. An email address lookup service 22 is connected for communication with the advertiser 16, as is an email service company 24. While communication connections are shown directly between entities for clarity, the actual communications may be routed through the Internet, or various other shared or private communications networks or connections.

Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities. When entities are described as being connected to the Internet, it is understood that the company maintains computer servers and other suitable equipment for communicating with other entities via the Internet.

The advertising service company (ASC) 20 is also connected to the Internet, and provides certain services to advertisers and publishers. Such services may include placement of advertisements on a publisher's digital property, consulting services for placement of the advertiser's advertisements on other advertising digital properties, and collection and analysis of information about the advertiser's and publisher's customers and visitors to the advertiser's and publisher's digital properties. Advertisements may come in various formats, such as email text, email html, banner, etc. Publishers may sell space on various media, such as email, web pages, search results, newsletters etc.

Each of the above commercial entities is connected to the Internet for communication with the others as needed, and all databases are maintained in secrecy, so that they are inaccessible to other entities, except as noted below. Consequently, private or personal information transmitted to any one entity may be utilized directly only by that entity.

Each entity in the above system typically includes one or more central processing units (CPUs) for executing computer programs such as the facility described below, a computer memory for storing programs and data, and a computer-readable media drive, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

The process of operation of the facility involves the generation of useful marketing data about the effects of Internet marketing efforts on an advertiser's “off-line” customers. Off-line customers are those who have a customer history with conventional service providers or “brick and mortar” stores, or other non-Internet retail channels such as mail or phone order. Off-line transactions differ from online transactions in that on-line transactions permit the advertiser or its agents to collect a unique device identifier or cookie from a customer or user, and then recognize this same user (or the device being used) when later transactions occur. In addition, advertising service companies may collect web browsing activity data to establish a browsing profile for that cookie, which may provide useful marketing information to effectively reach that user with appropriate advertisements, even when the identity of the user is not known.

In the preferred embodiment, the advertiser 16 has a database of existing customers. This database includes information that personally identifies the individuals. This may include mailing address, credit card number, phone number, and/or other such information. In the preferred embodiment, the offline customer database is comprised principally of those customers who have not purchased or provided personally identifiable information to the advertiser on-line. The database may also include those who may have provided an email address, or from whom an email communication has been received, although those for whom an email is known may not require the email lookup step detailed below.

The facility above and method below involve the issues of preserving user privacy while using all available analytic tools and information to provide effective advertising efforts. Accordingly, this application hereby incorporates by reference the disclosure of U.S. patent application Ser. No. 09/870,969, filed May 30 2001, entitled Method of Generating Commercial Email Communications While Preserving Internet Privacy.

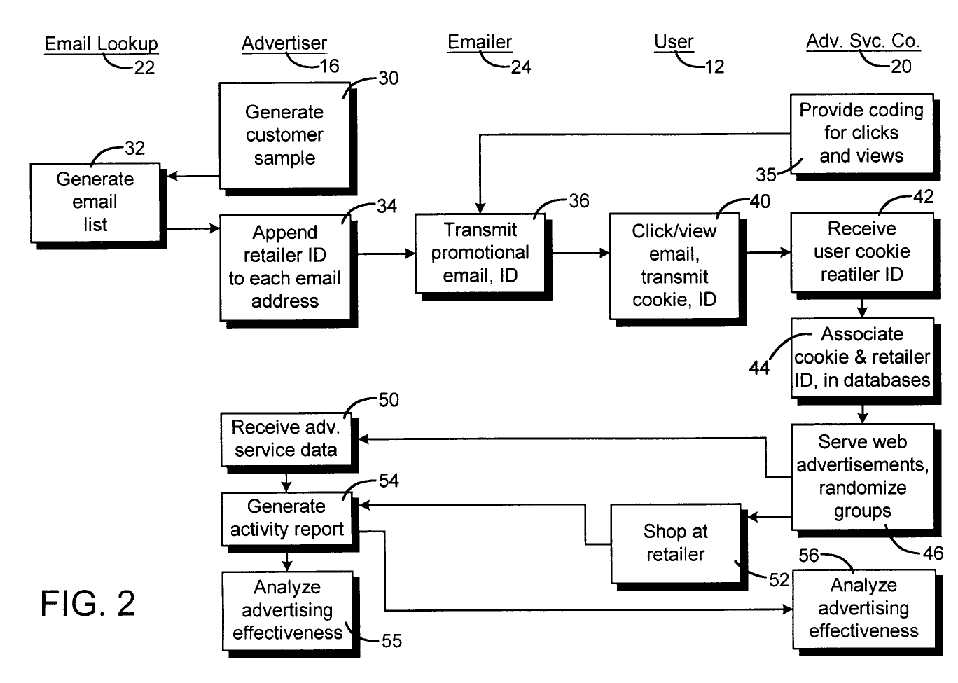

As shown in FIG. 2, the process involves the advertiser generating a sample of customers in step 30. Depending on the advertiser and how frequently interactions of interest (e.g., a sale) with customers occur, this is preferably a large sample, say of at least 100,000 customers, perhaps as large as several million. The larger the better, cost of matching digital addresses to customers allowing. This sample is randomly drawn from all of those customers, especially those for whom there is inadequate online information. At minimum, the size of the list with digital addresses matched with customer identifiers should be large enough to provide a desired likelihood of being able to identify differences in customer activities between the test group behaviors. This minimum size is determined by standard statistical power calculations that are dependent on the variability of consumer behavior, the frequency of consumer activity, the statistical confidence desired, and the size of the difference between test group activities. The minimum list size will vary sharply from implementation to implementation. The database and the selection of the sample may be conducted by an agent of the advertiser, as may many of the steps of the described process.

In step 32, the advertiser has transmitted the entire set of or a sample of database records to a digital address lookup service, such as an email append service. This may also be conducted in-house, or by automated means. An email service, for example, currently has yields expected to range between 20-40% of the list of database records. The email lookup service appends email addresses to those records of the database where possible, and returns the database to the advertiser. In step 34, the advertiser appends a unique ID code to each record for which an email address was identified. This may occur prior to step 32 in alternative embodiments. The database records for which email addresses were identified is the email list.

The advertiser then generates a promotional advertisement to be sent via email to the members of the email list. The advertiser may do this independently, or may engage an agency. The advertiser then transmits the email list with advertiser IDs and the promotional advertisement to an emailer. The advertiser may not use an emailer but instead may send emails to recipients directly. In step 35, the advertising service company (ASC) then provides coding (e.g., extended data action tags, view and click redirects) to the advertiser or the emailer to include in the email that provide instruction to user computers regarding where to download images included in the email and what web page to go to upon clicking links. An extended data action tag is a programmed request, triggered by a user's request to view the advertiser's web page, for a one-bit transparent image that does not appear to the user, but which triggers the user's computer to retrieve the image from the ASC. When serving the image to the user, the ASC collects the data transmitted in the action tag, and can store this data in its database, indexed by the ASC's cookie ID. The action tag can include any short set of data strings, but would capture the advertiser's cookie for this implementation.

In step 36, the advertiser or emailer sends the message to each user on the email list. The advertiser or the emailer ensures, through using widely used personalization technologies, that the advertiser ID is personalized for each email recipient's ASC coding. Upon receipt, at least some of the recipients will open, view, click, and/or otherwise act based on receiving the message in step 40. To view the entire message or click on links, image content or instructions on what site to click through to must be received from the advertising service company (ASC) 20. In an automatic and apparently instantaneous process, a user's attempt to view or click on the advertisement involves his web-browsing software sending a request to the ASC. The request includes the coded advertiser-assigned user identifier, which is received and recorded by the ASC in step 42 along with a cookie that will probably have already been assigned by the ASC to the user's computer or other browsing device. If a cookie had not been assigned, one is assigned at this transaction.

The ASC 20 associates the ID with the cookie in step 44, storing the ID in an ASC database in a record that already contains the cookie; the database may also contain other past browsing activity data for that cookie. If no previous cookie record exists, then one is created upon assignment of a cookie.

This process of sending emails to the email list may be repeated to increase the number of message views by the users, and to increase the percentage of list members for who a cookie-ID association is generated. It is believed that a successful repeated effort may generate up to about a 70-80% match. In step 46, before, during or after this matching takes place, the ASC conducts an advertising process of serving test and control advertisements to Internet users, which include the users on the email list. As the ASC is in the business of serving advertisement for many different advertisers, and has engaged advertising space at the websites of many different web publishers, it can be expected to occasionally serve advertisements to the members of the email list over a period of time, as they engage in normal web browsing.

When a list member visits a site where the ASC is to serve an advertisement, the user's cookie is read by the ASC, and the user is identified as a participant in the advertiser's effort. Thus, the user is served the advertiser's advertisement whose effectiveness is being tested. As part of its advertising process, the ASC has randomly assigned various parts of its cookie universe to receive various advertising treatments. If the user was assigned to the control group, he is either served a “dummy” advertisement having no relation to the advertiser, or is served no ad at all. This may be advertisement for a charitable organization, or other public service announcement. In alternative embodiments, the control advertisement may be another one of the advertiser's advertisements, to determine if the test advertisement generates improved results. Because the ASC has used a random technique to assign its cookies into treatment groups, the cookies that become linked to advertiser IDs will also be randomly assigned to these treatment groups.

After a period of serving advertisements, or in an ongoing process, the ASC transmits to the advertiser the advertising service data in step 50. This data identifies the advertising treatments given to each matched advertiser IDs reached in the advertising campaign. For privacy reasons, the data transmitted to the advertiser should not include any of the web activity information collected and stored for each user by the ASC. In fact, the advertiser should not learn which website the users visited to view the advertisement, nor what time of day, from what location, or any of a wide range of data elements that the ASC may collect. This ensures that the entity (the advertiser) that knows the personal identity of users does not know the browsing habits that users might consider to be private. Similarly, the ASC is prevented from knowing any personally identifying information about the users by the advertiser's use of a user ID, which contains no discernible identifying data, except to the advertiser. In alternative embodiments and variations, there may be data transmitted from the advertiser to the ASC, such as when the advertiser collects its own browsing data, and the ASC is to perform the analysis discussed below.

During a suitable time after receiving a served advertisement, a user may shop at the advertiser in step 52. Because the user had never previously shopped online at the advertiser, this is presumed to be an offline shopping visit. If the shopping were online, the results may still be useful to learn the effect the advertisement had on online shopping, although conventional methods would have been able to analyze this effect. When a user shops at the advertiser, the activity is recorded in an advertiser database record including his advertiser-assigned user ID. When adequate time has elapsed for a significant number of users who were served advertisements to have shopped at the advertiser, the activities of the test and control groups are generated from the database and reported by the advertiser in step 54.

In step 55, the advertiser can, on an aggregate level, assess the effect of the test advertisement. Essentially, the percentage of those who were served the test ads that subsequently shopped (or engaged in other desired activity) is calculated, as is the percentage who shopped among those who received the control advertisement. These percentages are compared to determine is the test ad generated a higher rate of shopping. If so, a “lift” factor is calculated that represents the percentage by which the advertisement may be expected to increase desired results, such as gross profit margins on sales.

In alternative embodiments such as step 56, the ASC may perform most of the analysis of advertising performance, requiring only that the advertiser transmit to the ASC the sales data, indexed by user ID. The sales data need not provide any user information other than the key element being measured, such as gross profit margin per user. Then, the ASC can conduct the comparisons and calculations, and in appropriate cases demonstrate to the advertiser the financial benefits of online advertising to generate offline sales. The benefits may be weighed against the cost to establish a return on investment value that can guide future strategy. This alternate approach is best if more detailed information is desired, such as whether advertising at one site was more effective at generating a given consumer activity than advertising at another site, or what the effect was of various frequencies of viewing advertisements was for different cookies. The alternate approach is best because it allows detailed analysis of advertising results by various web surfing variables (e.g site “a” vs. site “b”,) avoiding the ASC providing web surfing behavior to the advertiser in a way that can be linked to personally identifiable information. In steps 55, 56 or both, the analysis may be made based on any number of factors, including treatment group, site, and frequency.

The above system may further enhance an advertiser's understanding of their customer by extending the link between the advertiser ID and the ASC cookie ID to include a link to the advertiser's cookie ID for its web site. To make this additional link, the ASC places an “extended data action tag” on the advertiser's website. Once this process was in operation for a sufficient amount of time, the ASC could query its database to generate a list of cookie IDs that had both a corresponding advertiser customer ID and a corresponding advertiser cookie ID. Then, this list of matched advertiser cookie IDs and advertiser customer IDs could be transmitted to the client to enable a deep analysis of customer activity patterns by advertiser customer segment

For instance, the advertiser may previously have been analyzing browsing pattern data for all browsing customers, but now may examine a subset of particular interest. The subset may be limited to customers who make the largest off-line purchases, and then examined for which pages they use the most. If it were found that the best customers tend to spend the most time using a search function, that might be made more robust, or include special promotions for high-priced merchandise. On the other hand, if the best customers simply use the off-line store locator of the site, the web site might be designed differently. Unlimited information about the user's activities might be employed, including whether goods left in an online shopping cart are later purchased offline.

While the above is discussed in terms of preferred and alternative embodiments, the invention is not intended to be so limited.

1. A method of evaluating the commercial effects of Internet-based communication, comprising:
providing a customer database of past offline customers;
for each customer, attempting to determine an email address;
generating an email list of the determined email addresses assigning a different identifier to each address;
transmitting a promotional email to the determined email addresses; and
in response to a user acting in response to the email, collecting the identifier and associating it with a device identifier associated with the user.

2. The method of claim 1 including generating a subset of customers from the database including randomly selecting a selected number of customers.

3. The method of claim 2 wherein a first entity generates the subset, and wherein attempting to determine an email address includes the first entity transmitting limited information about the subset to a second entity that employs an email database.

4. The method of claim 3 wherein the limited information includes a credit card number.

5. The method of claim 1 including segregating the email list into various treatment groups and over a time interval serving various advertising treatments to the groups.

6. The method of claim 1 including segregating the email list into a control group and a test group, and over a time interval serving a test advertisement to the test group and a control advertisement to the control group.

7. The method of claim 6 wherein the control advertisement has content commercially unrelated to the content of the promotional email.

8. The method of claim 6 wherein the control advertisement is a public service announcement.

9. The method of claim 6 including recording a purchasing activity level of the test group and of the control group, and comparing the purchasing activity levels to determine the effect of the test advertisement.

10. The method of claim 5 including recording a purchasing activity level of the various treatment groups and comparing the purchase activity levels to determine the effect of the various treatments.

11. The method of claim 1 wherein monitoring web browsing activity includes collecting a unique identifier from users visiting a website, and determining if the unique identifier is associated with a user on the email list.

12. The method of claim 1 including preserving the privacy of users by securing personally identifying customer information at a first entity, and preventing access to the information by a second entity having access to web-browsing information about users.

13. The method of claim 12 wherein the first entity assigns a unique identifier to each user, and wherein the second entity collects the identifier in response to activity by the user.

14. The method of claim 13 wherein the activity includes at least one of web browsing activity and offline purchases subsequent to the promotional email.

15. The method of claim 1 including monitoring offline purchasing activity and analyzing web site browsing activity with respect to the purchasing activity.

16. The method of claim 15 wherein analyzing the monitored web browsing activity with respect to the purchasing activity includes identifying, for a subset of users with selected offline purchasing characteristics, the preferred web pages visited, such that the preferred web pages may be designed with regard to the subset of the users.

17. A method of evaluating the commercial effects of Internet-based communication, comprising:
generating a sample of offline customers;
for each customer in the sample, attempting to determine an email address;
generating an email list of the determined email addresses;
assigning a unique customer identifier to each customer on the email list;
transmitting a promotional email including the unique customer identifier to the determined email addresses;
recording user online activity in response to the promotional email, including associating a user device cookie with the unique customer identifier; and
recording offline purchasing activity for each customer, including associating the unique customer identifier with the offline purchasing activity.

18. The method of claim 17 including preserving customer privacy by maintaining personal information about each customer with a first entity, maintaining recorded online activity with the second entity, such that personal activity and online activity are not commonly held by any entity.

19. The method of claim 17 including segregating the email list into a control group and a test group, and over a time interval serving a test advertisement to the test group and a control advertisement to the control group, and comparing the offline purchasing activities of the groups to determine the effect of the test advertisement.

20. The method of claim 17 wherein recording user online activity includes identifying, for a subset of customers with selected offline purchasing characteristics, the preferred web pages visited, such that the preferred web pages may be designed with regard to the subset of the users.

21. The method of claim 17 including segregating the email list into various treatment groups, and over a time interval serving a test advertisement to the treatment groups, and comparing the offline purchasing activities of the groups to determine the effect of the advertisement treatments.

22. A method of evaluating the commercial effects of Internet-based communication, comprising:
a commercial entity generating a sample of offline customers;
for each customer in the sample, attempting to determine an email address;
generating an email list of the determined email addresses;
assigning a unique identifier to each customer on the email list;
transmitting a promotional email including the unique identifier to the determined email addresses;
a second entity recording user online activity in response to the promotional email, including associating a user device cookie with the unique customer identifier; and
recording subsequent offline purchasing activity for each customer, including associating the subsequent offline purchasing activity with the cookie.

23. The method of claim 22 including segregating the email list into a control group and a test group, and over a time interval serving a test advertisement to the test group and a control advertisement to the control group, and comparing the offline purchasing activities of the groups to determine the effect of the test advertisement.

24. The method of claim 22 including segregating the email list into various treatment groups, and over a time interval serving a test advertisement to the treatment groups, and comparing the offline purchasing activities of the groups to determine the effect of the advertisement treatments.
